(19) United States
(12) Patent Application Publication
(10) Pub. No.: US 2014/0108033 A1
(43) Pub. Date: Apr. 17, 2014

(54) HEALTHCARE ENTERPRISE SIMULATION MODEL INITIALIZED WITH SNAPSHOT DATA

(71) Applicants: Kunter Seref Akbay, Niskayuna, NY (US); Christopher Donald Johnson, Niskayuna, NY (US); Angela Neff Patterson, Blacksburg, VA (US); Andrew Phelps Day, Newtown, PA (US); Ilkin Onur Dulgeroglu, Niskayuna, NY (US); David S. Toledano, Niskayuna, NY (US); Bex George Thomas, Niskayuna, NY (US); Dan Yang, Niskayuna, NY (US); Peter Leigh Katlic, Niskayuna, NY (US); Marcia Peterson, Niskayuna, NY (US)

(72) Inventors: Kunter Seref Akbay, Niskayuna, NY (US); Christopher Donald Johnson, Niskayuna, NY (US); Angela Neff Patterson, Blacksburg, VA (US); Andrew Phelps Day, Newtown, PA (US); Ilkin Onur Dulgeroglu, Niskayuna, NY (US); David S. Toledano, Niskayuna, NY (US); Bex George Thomas, Niskayuna, NY (US); Dan Yang, Niskayuna, NY (US); Peter Leigh Katlic, Niskayuna, NY (US); Marcia Peterson, Niskayuna, NY (US)

(21) Appl. No.: 14/029,405

(22) Filed: Sep. 17, 2013

Related U.S. Application Data
(60) Provisional application No. 61/712,629, filed on Oct. 11, 2012.

(51) Int. Cl. G06Q 50/22; G06Q 10/06

(52) U.S. Cl. CPC G06Q 50/22; G06Q 10/06315
USPC 705/2

(57) ABSTRACT

Snapshot data may be received indicative of a current state of resources that deliver healthcare to a plurality of patients associated with a healthcare enterprise. The received snapshot data may be automatically used to initialize a healthcare enterprise simulation model. The healthcare enterprise simulation model may then be executed to automatically generate a predicted future state of the resources at a predetermined point in time. Some embodiments may automatically suggest mitigation strategies based on simulated scenarios reflecting potential bottlenecks and appropriate actions that may be taken by the enterprise. The system may continuously and automatically monitor forecast accuracy to detect potential anomalies.

### CROSS-REFERENCE TO RELATED APPLICATIONS

The present application claims the benefit of U.S. Provisional Patent Application Ser. No. 61/712,629 entitled “SYSTEM AND METHOD TO FORECAST KEY RESOURCE BOTTLENECKS IN A HOSPITAL FOR PROACTIVE OPERATIONAL DECISION SUPPORT” and filed on Oct. 11, 2012. The entire content of that application is incorporated herein by reference.

### BACKGROUND

A healthcare enterprise, such as a hospital, may utilize resources to deliver healthcare to patients. For example, a hospital may have a limited number of hospital beds that can be assigned to patients. As a result, resource and patient flow management may be an important responsibility of a healthcare provider. In some cases, a balance between inpatient bed capacity/staffing levels and current/expected patient demand may need to be maintained across a period of time (e.g., through the next 24 hours). To help maintain such a balance, a healthcare provider may re-target patient placements and/or open or close healthcare units and beds based on existing and upcoming capacity and demand.

Failing to properly manage resource and patient flow may result in substantial admission waits (e.g., “boarding” patients in an emergency department) and reduce safety due to imbalances between nurse staffing and current inpatient census (often as a result of unanticipated variability in patient flow). Moreover, failing to manage patient bed occupancy may result in higher overall medical costs by increasing the average duration of inpatient stays, causing unnecessary ambulance diversions, etc.

Typically, a healthcare provider focuses on quantifying current conditions and planning for deterministic future events. In many cases, however, a throughput crisis may not be fully appreciated until after the consequences have affected the facility. At many facilities operational success depends on a few select individuals who attempt to track patient flow through the entire organization and “bed huddle” meetings to assess daily capacity needs. For example, bed huddle meetings (usually held in the morning and in the late afternoon) may let managers with operational decisioning responsibilities in key departments/units meet in person and provide the current census and anticipated patient admissions, discharges, and transfers. A net bed demand may be estimated based on the starting occupancy and anticipated inflows and outflows for each unit, and then be further adjusted based on the staff availability. Such an approach, however, is manually intensive and depends on each person's judgment. Furthermore, it may be difficult to predict potential bottlenecks and there is little ability to assess the outcomes that may result if certain actions were taken to avoid potential problems proactively.

It would therefore be desirable to provide systems and methods to facilitate accurate resource and patient flow management in an automated, efficient, and consistent manner.

### BRIEF DESCRIPTION OF THE DRAWINGS

FIG. 1 is block diagram of a system according to some embodiments of the present invention.

FIG. 2 illustrates a method that might be performed in accordance with some embodiments.

FIG. 3 illustrates a patient flow model at a “molecule” level according to some embodiments of the present invention.

FIG. 4 illustrates a hospital patient flow according to some embodiments of the present invention.

FIG. 5 illustrates a unit level hierarchy according to some embodiments of the present invention.

FIG. 6 illustrates a high level workflow according to some embodiments of the present invention.

FIG. 7 illustrates system components according to some embodiments of the present invention.

FIG. 8 illustrates floor plan level patient tracking according to some embodiments of the present invention.

FIG. 9 is block diagram of a tool or platform according to some embodiments of the present invention.

FIG. 10 is a tabular portion of a database of predicted resources output according to some embodiments.

FIG. 11 illustrates a process that might be performed in accordance with some embodiments.

FIG. 12 illustrates a service-line resource prediction display that might be provided according to some embodiments.

FIG. 13 illustrates a unit level forecast display that might be provided according to some embodiments.

FIG. 14 illustrates a low bed availability display that might be provided in accordance with some embodiments.

FIG. 15 illustrates a destination unit probability configuration display that might be provided in accordance with some embodiments.

FIG. 16 is an example of a forecasted occupancy daily calibration display according to some embodiments.

### DETAILED DESCRIPTION

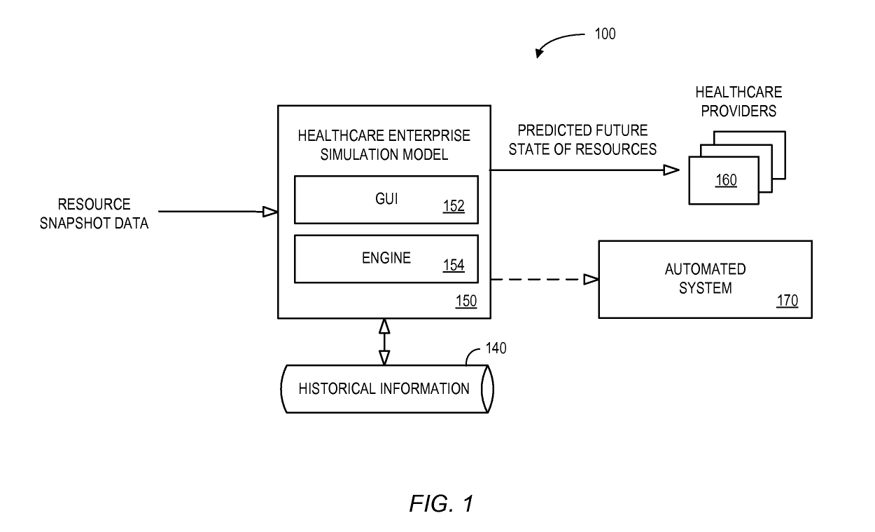

A healthcare enterprise, such as a hospital, may utilize resources to deliver healthcare to patients. For example, a hospital may have a limited number of hospital beds that can be assigned to patients. As a result, resource and patient flow management may be an important responsibility of a healthcare provider and it would therefore be desirable to provide systems and methods to facilitate accurate resource and patient flow management in an automated, efficient, and consistent manner. FIG. 1 is block diagram of a system 100 according to some embodiments of the present invention. In particular, the system 100 includes a healthcare enterprise simulation model 150 that receives resource “snapshot” data (e.g., from a real time location system). According to some embodiments, the healthcare enterprise simulation model 150 may also receive information, such as electronic files, from other hospital information systems, such as Admission Discharge Transfer (“ADT”) data. The healthcare enterprise simulation model 150 may also access a historical information database 140 (e.g., to predict how many patients will visit an emergency department on a Sunday afternoon). The healthcare enterprise simulation model 150 might be, for example, associated with a Personal Computer (PC), laptop computer, an enterprise server, a server farm, and/or a database or similar storage devices. The healthcare enterprise simulation model 150 may, according to some embodiments, be associated with a hospital.

According to some embodiments, an “automated” healthcare enterprise simulation model 150 may facilitate resource and patient flow management using a Graphical User Interface (“GUI”) 152. As used herein, the term “automated” may refer to, for example, actions that can be performed with little or no human intervention. The healthcare enterprise simulation model may use the resource snapshot data and generate a predicted future state of resources that can be provided to healthcare professionals 160, such as nurses or managers. According to some embodiments, an engine 154 may facilitate the generation of such predictions. The healthcare enterprise simulation model 150 might also transmit information to an external automated system 170, such as a report generator, workflow application, email notification system, pager application, Short Messaging System (“SMS”) gateway, or the like.

As used herein, devices, including those associated with the healthcare enterprise simulation model 150 and any other device described herein, may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks. Moreover, embodiments may be implemented in a “cloud” based environment such that at least some of the processing is performed by a remote system.

The healthcare enterprise simulation model 150 may store information into and/or retrieve information from the historical information database 140. The historical information database 140 may be locally stored or reside remote from the healthcare enterprise simulation model 150. Although a single healthcare enterprise simulation model 150 is shown in FIG. 1, any number of such devices may be included. Moreover, various devices described herein might be combined according to embodiments of the present invention. For example, in some embodiments, the claim healthcare enterprise simulation model 150 and historical information database 140 might be co-located and/or may comprise a single apparatus.

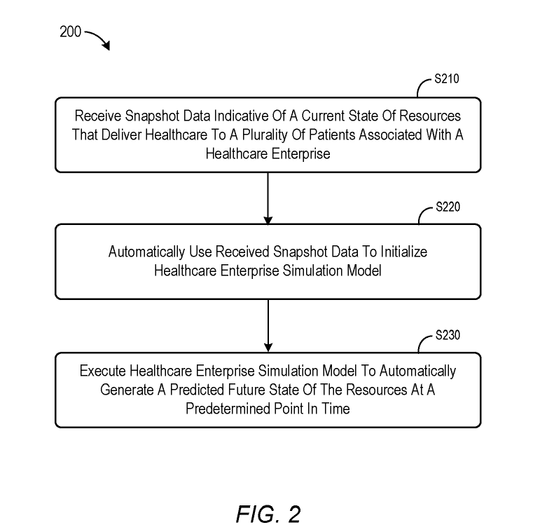

FIG. 2 illustrates a method that might be performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, snapshot data is received indicative of a current state of resources that deliver healthcare to a plurality of patients associated with a healthcare enterprise. According to some embodiments, the method 200 of FIG. 2 is periodically performed (e.g., on a daily basis, every six hours, etc.). The resources may be associated with, for example, patient beds, staffing, and/or medical equipment and the snapshot data may be received from, for example, a real time location system utilizing Radio Frequency Identifier (“RFID”) information. Note that the method 200 of FIG. 2 may, according to some embodiments, be performed responsive to a request for a report (e.g., from a nurse) and/or responsive to an occurrence of an event (e.g., the arrival of five or more new patients in an emergency room in a single hour).

At S220, the received snapshot data is automatically used to initialize a healthcare enterprise simulation model. Note that the model may have been previously configured based on the structure of the healthcare enterprise. For example, the configuration might involve defining a plurality of treatment “units” of the healthcare enterprise simulation model and defining patient flow characteristics into, within, between, and out of the plurality of treatment units. As used herein, the phrase “treatment unit” might refer to real or virtual hospital locations having specific, limited patient capacities; for example, an emergency department, an outpatient unit, a holding room, an operating room, a recovery room, a cardiac treatment unit, a physical therapy unit, an X-ray and MRI unit, and/or an intensive care unit.

At S230, the healthcare enterprise simulation model is executed to generate a predicted future state of the resources at a predetermined point in time. For example, the model might predict a number of available patient beds over the next 24 hours. According to some embodiments, the model generates a plurality of predicted future states of the resources, each associated with a different predetermined point in time. According to some embodiments, the model also receives scheduled future events and the predicted future state of the resources is further based on the scheduled future events (e.g., the number and type of surgeries scheduled for a particular day). Note that the predicted future state of the resources may also be based on predicted future events (e.g., based at least in part historical information of the healthcare enterprise).

According to some embodiments, a potential patient flow bottleneck may be automatically detected by the healthcare enterprise simulation model. For example, the model might detect that too many patients are going to be assigned to a particular medical unit. In this case, a warning may output when the potential patient flow bottleneck is detected and/or a mitigation recommendation may be automatically generated.

According to some embodiments, the predicted future state of the resources at the predetermined point in time may be automatically compared with the actual state of the resources at the predetermined point in time. For example, a predicted number of available patient beds a 5:00 PM might be compared to the number of beds that were actually available at that time. Moreover, based on a result of said comparison, the healthcare enterprise simulation model might automatically adjusted (e.g., to improve the performance of the model).

According to some embodiments, the healthcare enterprise simulation model is parametrically driven and hot started based on periodic snapshots of the hospital state. Moreover, possible alternative future states of the hospital may be predicted for upcoming work shifts to provide early visibility into potential resource bottlenecks (e.g., bed shortages) and proactive feedback to decision makers regarding potential alternatives to avoid or minimize the impact of such bottlenecks. These mitigation alternatives may include, for example: the timely discharge or transfer of patients; adjustments to housekeeping and patient transport priorities and staffing decisions to improve patient flow; nursing level decisions in view of patient care requirements; bed assignment modifications and/or changes in priorities for patients to be admitted; clinical order prioritization adjustments for labs, imaging facilities and pharmacy units; changes to scheduled surgeries; and/or emergency room diversions.

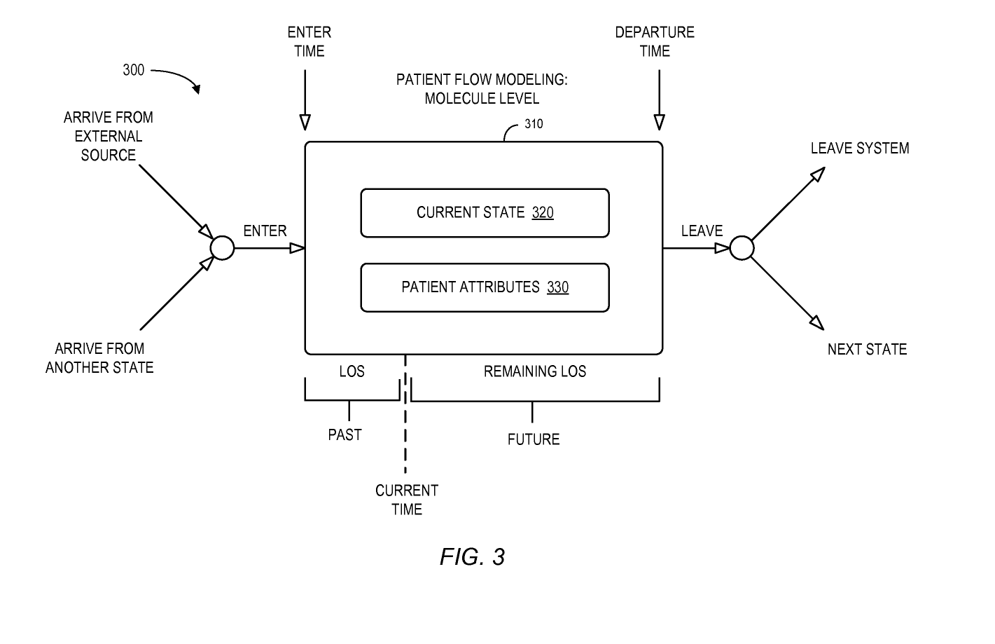

FIG. 3 illustrates a patient flow model 300 at a “molecule” 310 level according to some embodiments of the present invention. Note that the future state of a complex throughput system may be based on the current state of the system, future known events, future events predicted by history, and/or a transfer function representing the system's behavior. At any given point in time, a patient may be in a current state 320 where there is either a care activity or a wait/delay state for the next care activity to begin. For example, a patient can be either in a surgery or waiting in the holding area for the operating room and the necessary resources to become available. The patient enters into this current state 320 from either another state or an external source. For example, the patient may arrive into an Emergency Department (“ED”) via ambulance to be triaged by the nurse to assess his or her acuity level or may arrive into the Post Anesthesia Care Unit (“PACU”) area after a surgery is completed (e.g., where there is a bed and nurse available to help the patient recover from the anesthesia). External arrivals to the system might be driven by historical patterns of volume based on the time of the day or by schedules, such as patients who schedule surgeries in advance.

Regardless of how a patient arrives at the current state 320, there may be an entry and departure time associated with the current state 320. The Length Of Stay (“LOS”) in the current state 320 is the difference between the “current time” and the “entry time” to the state. How long a patient stays in the current state 320 may be based on many factors including pre-determined fixed time durations, patient attributes 330 (e.g., his or her acuity level), primary diagnoses, care activity times that have random distributions, availability of resources needed to perform the required care activity, and/or the dynamics of the system (e.g., the readiness of a next state to accept the patient with bed and/or nurse availability). The model may have a transfer function with the proper fidelity to “predict” the remaining LOS in the current state 320 by a patient.

In general, there are two possibilities for the next destination or state when the patient is ready or allowed to leave the current state 320: departure from the throughput system or entry into a next state (e.g., for queuing or additional care activity). The next step decision might be based on historical patterns (e.g., ED patients have 83% chance to be discharged or a 17% chance to be admitted) or based on a rule or condition (e.g., surgical patients must go to a PACU area for recovery). If the next state is not an exit, there may be a single or multiple possible next states (locations). In the case of multiple possible next states, the choice may be random (driven by historical patterns) or may depend on a rule. For example, for ED patients to be admitted into an inpatient unit there might be a set of specific units with a preferred order. If no space is available in any of those units, there may be less-desired alternatives. If none of those less-desired options are viable, the patient may need to remain in ED until a bed becomes available.

A patient move from the current state 320 to the next state may require additional resources, which may make the move times unpredictable. For example, a patient who must have a Computed Tomography (“CT”) exam performed might need to wait until a transport with a wheelchair becomes available. If the wheelchair is not available, the patient transport may be delayed along with the CT exam process which, in turn, may further delay this particular patient's and other patients' flow through the system. In general, the system resources are limited in number and in resource availability can have a substantial impact on patient wait times and overall system throughput.

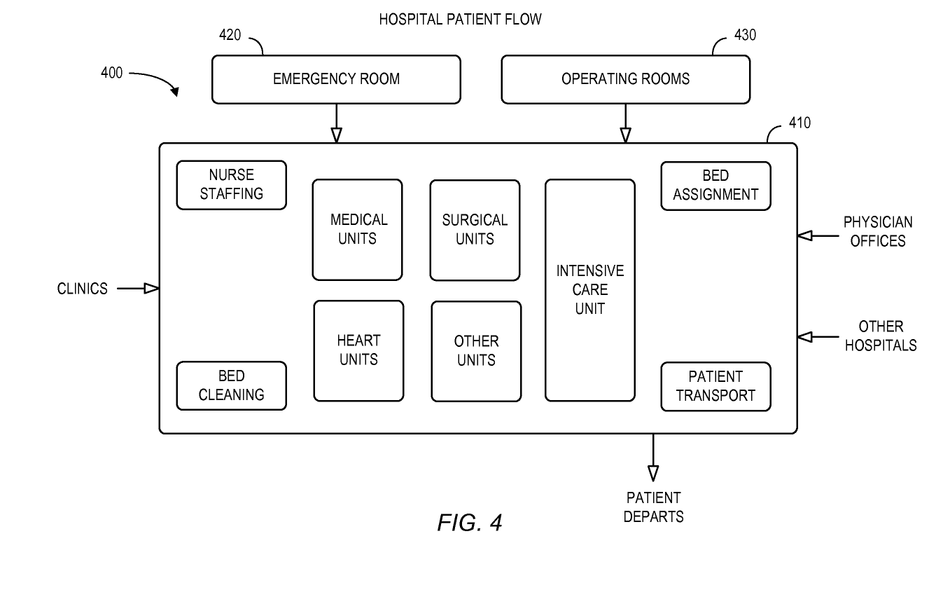

FIG. 4 illustrates a hospital patient flow 400 according to some embodiments of the present invention. The flow 400 includes inpatient services 410 that may receive patients from an emergency room 420, operating rooms 430, clinics, physician offices and/or other hospitals. The inpatient services 410 may include, for example, nurse staffing, bed cleaning, bed assignments, and patient transports associated with medical units, heart units, surgical units, intensive care units, and/or other units.

Such a patient flow 400 illustrates the complexity of a typical hospital system, which involves many linked components and high levels of variability. Note that new patient arrivals may be scheduled or unknown. Inpatient services may involve units of varying specialization that typically contain between 12 and 36 beds, and disposition from inpatient units may proceed to other parts of the flow 400 or to an external destination. In addition to the flow illustrated in FIG. 4, embodiments might be associated with rehabilitation units, psychiatric units, pediatric units, etc.

Note that patients may be delayed at any step due to capacity restrictions or “workflow” requirements such as surgical or emergency processes. The progress of a patient through the flow 400 may be highly uncertain and small deviations in patient flow can lead to substantial delays across the system if not addressed proactively. Managing patient throughput poses complex operational decisions over time scales from minutes to days. Some examples: whether “swing” capacity should be opened to avoid an upcoming bed-availability crisis; whether unit staffing should be revised to accommodate fewer (or more) patients; the range of admissions (or discharges) that should be expected today in each area and the likelihood that particular areas will be unable to accommodate demand; whether admissions from ED should be re-prioritized versus surgery units; whether some units need priority for bed cleaning or transportation; and/or where pending admissions should be sent in order to minimize potential bottlenecks while still maintaining appropriate levels of care.

The hospital flow 400 presents considerable uncertainty and numerous interdependencies, and a “whole hospital” forecast may address both of these issues and may: reflect system-wide interconnections; incorporate real-time data updates (including current patient status and any capacity or throughput restrictions); be able to model potential alternative tactics as well as “typical” behaviors; and/or avoid use of clinical health information (which may be subject to privacy restrictions). According to some embodiments, a system level discrete event simulation based on patient level data may be provided.

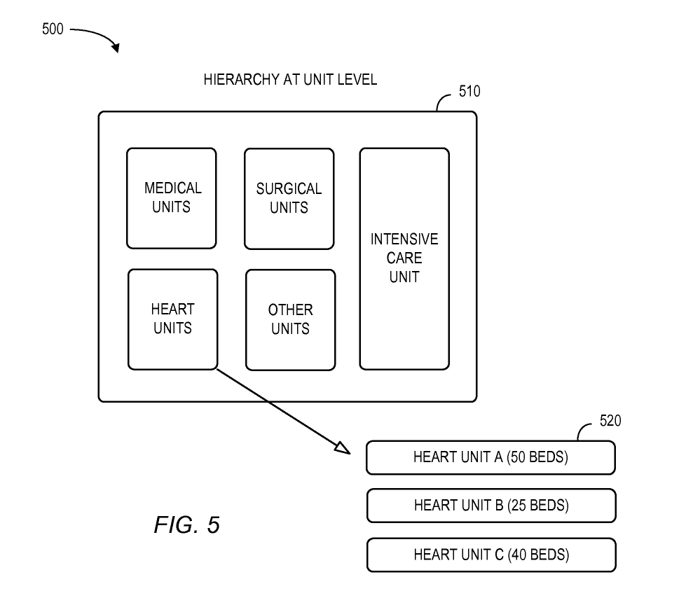

Note that each of the units illustrated in the hospital patient flow 400 may itself comprise a number of units. For example, FIG. 5 illustrates a unit level hierarchy 500 according to some embodiments of the present invention. In particular inpatient services 510 includes a heart unit which itself is composed of heart unit A (50 beds) 510, heart unit B (25 beds), and heart unit C (40 beds). A healthcare enterprise simulation model may receive snapshot data for and/or make resource predictions for each of these units 510.

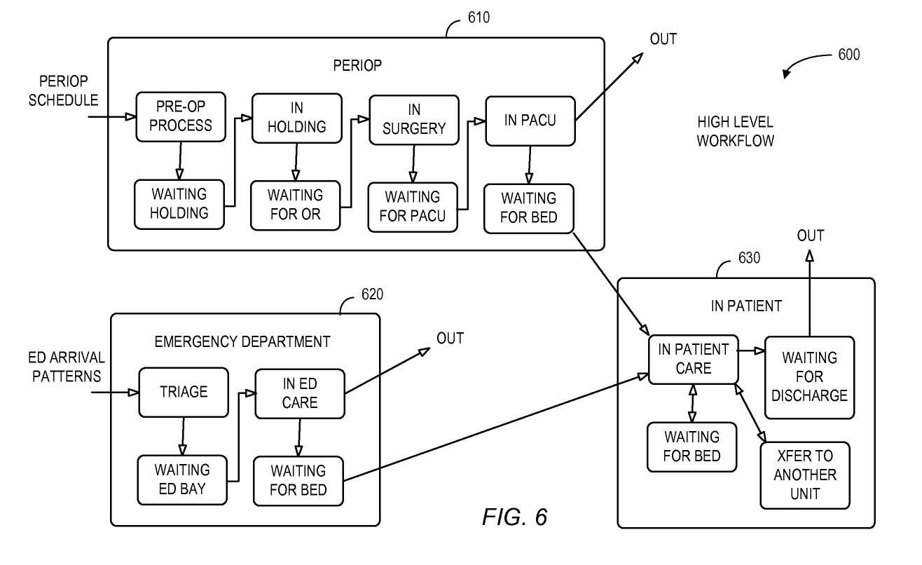

FIG. 6 illustrates a high level workflow 600 according to some embodiments of the present invention. Note that the molecule 310 described with respect to FIG. 3 may comprise a building block for an overall patient care delivery throughput system. Moreover, the workflow 600 includes a perioperative area (“PERIOP”) 610 for surgical patients, an emergency department 620, and inpatient services 630. Other sources of patients might include a catheterization laboratory for heart patients, direct admits from the physician offices, and/or transfers from other hospitals. Depending on their condition, patients in ED and PERIOP may need to be admitted to inpatient services, or may be discharged from the hospital.

The inpatient services 630 units might represent locations where a patient spends at least one night in the hospital in order to go through the care plan appropriate for his or her treatment. The patients who are medically ready to leave the hospital are “discharged.” Sometimes a patient may be “transferred” to another inpatient services 630 unit to continue their care process.

Note that surgical patients are usually scheduled in advance. However, sometimes unscheduled surgeries (e.g., due to an emergency) are added to the schedule with little advance notice and this may impact the flow of scheduled patients. A surgery may require a patient to be admitted to an inpatient unit or a patient may be discharged after the surgery. The high level steps for surgery patients may include pre-operation activities to prepare the patient for the surgery, a holding stage where additional exams by the surgeon, nurse and the anesthesiologist may be conducted, the operating room where the actual surgery takes place, and a recovery room PACU to assure that the patient is medically ready to move on. At any given time, a surgical patient may be in any one of these value-added states or may simply be waiting for the resources or capacity (staff, equipment, room, etc.) to become available.

Patient arrivals to the ED are usually unscheduled. The first step is usually a triage activity to prioritize the care needed based on the patient's acuity level. Once the triage and the registration processes are completed, the patient waits until there is a room/bay available for the assessment and treatment. Due to random arrivals and dynamic acuity levels, the patient's priority may change frequently as new patients arrive into the system. Once a space becomes available, several nursing and physician assessments are conducted, clinical orders (lab, imaging, etc.) may be placed and fulfilled, and eventually a disposition decision is made whether to admit or discharge the patient.

The level of detail needed to accurately represent the real system and to predict its capacity in the future depends on the data availability and the objectives of the prediction capability. Some embodiments described herein provide a flexible, scalable and generic capability to model the transfer function properly. Moreover, some embodiments may leverage a generic, data driven, parametric simulation modeling toolkit to model complex hospital operations by taking into consideration the interdependencies and the randomness contained therein.

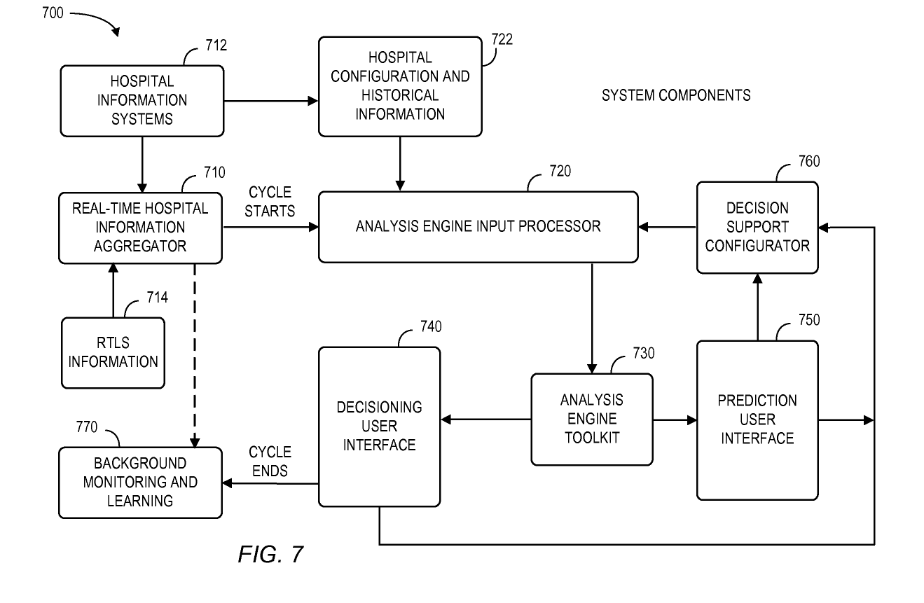

FIG. 7 illustrates system components 700 according to some embodiments of the present invention. A real time hospital information aggregator 710 may receive data from hospital information systems 712 and/or Real Time Location Systems (“RTLS”) 714 pertaining to equipment, patients, and/or staff. The hospital information systems might include, for example, Admission Discharge Transfer (“ADT”) for inpatient, departmental systems for ED, PERIOP, a catheterization laboratory, ancillary systems for Lab, Pharmacy and Diagnostic Imaging (“DI”), scheduling systems for surgery, imaging, medical procedures, and financial systems (e.g. for billing).

The data from the hospital information system 720 may be used to extract information to characterize the hospital and its historical behavior. Automated data mining and knowledge extraction methods may be used to define, store and translate this information into a usable form for the hospital system transfer function. Typical information includes the names, location and the capacity for patient care units including the ED, PERIOP, intensive care units, where the required care is provided to the patients at this specific hospital as well as the processes and the resources required to deliver a specific type of care. The historical information for patient arrival volumes and patterns, process times, disposition probabilities, and discharge and transfer patterns and volumes may also be extracted from the data in order to be able to execute the operations of the molecule 310 structure described with respect to FIG. 3. All of this information may be periodically updated and stored by a hospital configuration and historical information component 722 in a database for modifications if and when necessary. In order to make this information usable by the hospital transfer function, a configurator routine can be executed to automatically build the model and populate the necessary tables that parametrically drive the model.

The model generation may comprise a one-time event for a particular site even though modifications to the structure and data may later be made to match the real-system evolution. An automated analytical workflow may drive the operational decisioning cycle which starts with an automatic capture of the “current” state at pre-defined intervals. For example, a snapshot of the system may be transmitted to an analysis engine input processor 720 at 6:00 AM, noon, 3:00 PM and 6:00 PM to update the forecast with the latest information during the period where there are significant patient flow activities such as new admits, surgery completions, discharges, and transfers. This real time information may include current state data such as patient location, workflow state, bed and resource availability, queue information, etc., and “scheduled” activities for surgery, external patient arrivals, etc. After being obtained, this information may be automatically processed for initializing or “hot-starting” the model and placed in a database for running simulation replications. Multiple replications may be executed, either in serial or parallel, to help quantify the potential range of future variation to be expected. Once replications are completed, the automated analytical workflow may distill the simulation output, perform the analysis required to forecast hourly bed availability/occupancy for each care unit/service/whole hospital and display them via a decisioning User Interface (“UI”) 740 and a prediction UI 750 via an analysis engine toolkit 730. The prediction UI 750 may be used to provide data to a decision support configurator 760 and the decisioning UI 740 may provide data to a background monitoring and learning component 770 at the end of the cycle.

Depending on how the system is set up, both running the simulation analysis and viewing the report could take place either in a cloud environment or on premise at the hospital. The system may, according to some embodiments, host certain analytical workflow steps on premise and other steps in a cloud.

Real-time input data might be obtained, for example, from an AgileTrac™ system available from GENERAL ELECTRIC CORPORATION® which has interfaces to multiple hospital information systems and databases. According to some embodiments, data may be provided as encrypted hourly “snapshots” describing the current state of all beds, patients, surgical cases, and bed requests across the hospital. Only a small subset of the data available in each source might be actually extracted for a “snapshot” to avoid use of private health data. Specific sources for a “snapshot” might include: an ADT database (indicating location, entry time and current status of each patient); surgical schedule, covering planned procedures and case start/end types; surgical workflow status, which tracks patient progress through various stages such as Pre-Op, Operating Room (“OR”) and recovery; bed requests (admission orders) for current and pending patients, listing basic needs such as specialty (orthopedics, cardiology, etc.), wait times and other criteria; discharge orders, indicating whether pending or confirmed and time order was written; and/or a bed board listing each inpatient bed and its current status (e.g., occupied, available/clean, available/dirty, cleaning in progress, blocked or otherwise out of service).

Note that data processing, simulation runs, and post-processing may be conducted on a dedicated secure server. Forecast reports may be generated and sent via e-mail to a configurable distribution list, and also encrypted and transferred to a cloud-hosted service for a controlled set of users to view on secure, password-protected web pages. According to some embodiments, outputs are used to create different types of display and reports for specific audiences.

As part of initial system set up for a new facility, the hospital's capacities, patient pathways across locations, and care types may be determined. The initial set up may be performed manually, utilizing historical patterns extracted from a AgileTrac™ data or any other hospital information system database archive including durations for length of stay in various units and care types, dispositions for patient movement between units, volumes of unscheduled arrivals, and variances within workflows. According to some embodiments, generating such patterns may be manually performed (e.g., by running a set of pre-defined SQL queries on a particular date range of historical data). According to other embodiments the generation of these patterns is automated.

The data mining for care pathways may be performed on a “first-principles” assumption that there are a limited (and known) number of paths by which patients can enter and exit each location. Some embodiments systematically extract the appropriate patterns and probabilities for each path based on the specific interconnections of a particular hospital's simulation model.

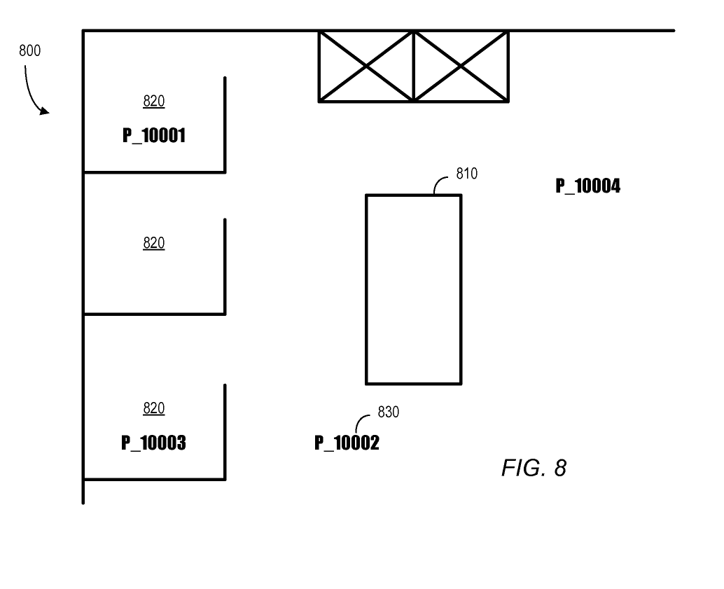

Note that the evaluation of real-time input may be fully automated. According to some embodiments, encrypted “snapshots” are sent to a system every hour, restored to a local database for processing, and used to modify the simulation model and generate entities reflecting known current/future patients and events. FIG. 8 illustrates floor plan level patient tracking 800 for a nurse's station 810 according to some embodiments of the present invention. Note that the system may track which patients (e.g., “P_{—}10001”) are in which rooms 820 or hallway 830 although this level of detail might not be displayed to the healthcare providers.

All inpatient units may be updated with a current number of potential beds by computing the total bed count and subtracting any blocked (out of service) beds. Each current and scheduled patient may, for example, be placed into one of a number of categories (as defined during model configuration, potentially differing for each healthcare facility) based on the data types present for them, which guides their specific care path. Each patient's category may be used to apply stochastic parameters and generate 100 replications (potential future paths) for that patient.

The simulation model may be “hot-started” by placing patients in their current locations with pre-elapsed stay durations (rather than the model beginning with an empty hospital), followed by adding future known/scheduled events such as planned admissions or surgical cases, and probabilistically-generated unscheduled arrivals of various types. 100 replications may be generated for all current patients as well as for future events and unscheduled arrivals, covering volume, arrival timing, and movement paths through the system. The model may be associated with a generic and parametrically driven discrete-event simulation construct built on an AnyLogic™ or any other simulation platform (which might requires little re-coding to accommodate different hospitals or care pathways).

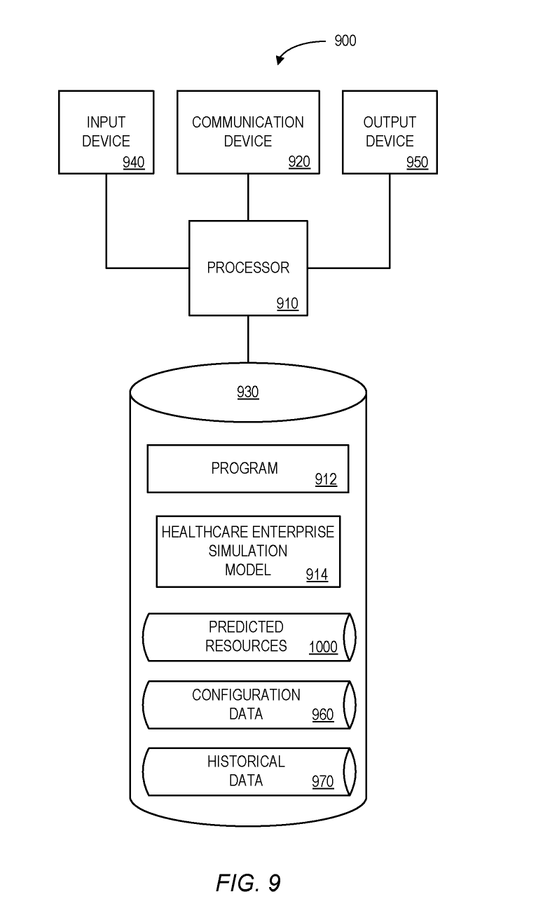

The embodiments described herein may be implemented using any number of different hardware configurations. For example, FIG. 9 is block diagram of a tool or platform 900 that may be, for example, associated with the system 100 of FIG. 1. The healthcare enterprise resource prediction platform 900 comprises a processor 910, such as one or more commercially available Central Processing Units (CPUs) in the form of one-chip microprocessors, coupled to a communication device 920 configured to communicate via a communication network (not shown in FIG. 9). The communication device 920 may be used to communicate, for example, with one or more remote devices (e.g., to receive snapshot data). The healthcare enterprise resource prediction platform 900 may further include an input device 940 (e.g., a mouse and/or keyboard to configure a healthcare enterprise simulation model) and an output device 950 (e.g., a computer monitor to display a graphical user interface and/or reports).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or a healthcare enterprise simulation model 914 for controlling the processor 910. The processor 910 performs instructions of the programs 912, 914, and thereby operates in accordance with any of the embodiments described herein. For example, the processor 910 may receive snapshot data indicative of a current state of resources that deliver healthcare to a plurality of patients associated with a healthcare enterprise. The received snapshot data may be used by the processor 910 to initialize the healthcare enterprise simulation model 914. The healthcare enterprise simulation model 914 may then be executed to automatically generate a predicted future state of the resources at a predetermined point in time.

The programs 912, 914 may be stored in a compressed, uncompiled and/or encrypted format. The programs 912, 914 may furthermore include other program elements, such as an operating system, clipboard application, a database management system, and/or device drivers used by the processor 910 to interface with peripheral devices.

As used herein, information may be “received” by or “transmitted” to, for example: (i) the healthcare enterprise resource prediction platform 900 from another device; or (ii) a software application or module within the healthcare enterprise resource prediction platform 900 from another software application, module, or any other source.

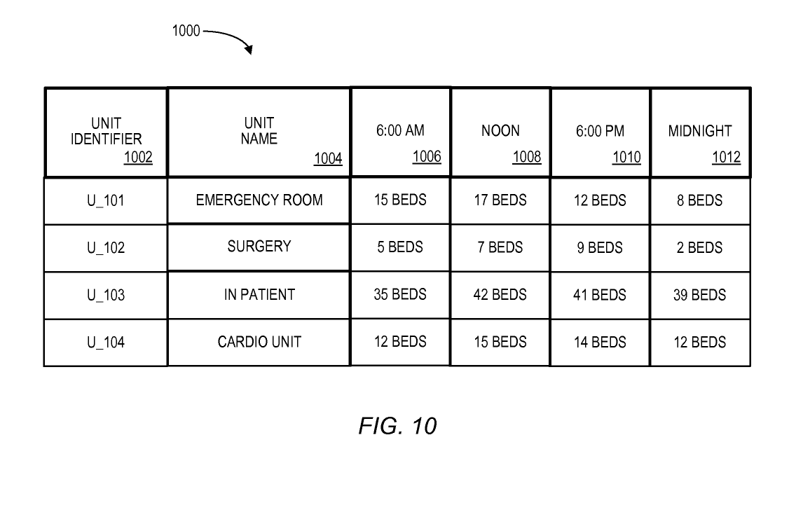

In some embodiments (such as shown in FIG. 9), the storage device 930 further stores a predicted resources database 1000, configuration data 960 (e.g., defining patient flow through the hospital), and historical data 970 (e.g., to predict unscheduled future events). An example of a database that may be used in connection with the healthcare enterprise resource prediction platform 900 will now be described in detail with respect to FIG. 10. Note that the database described herein is only one example, and additional and/or different information may be stored therein. Moreover, various databases might be split or combined in accordance with any of the embodiments described herein. For example, the predicted resources database 1000, configuration data 960, and/or historical data 970 might be combined and/or linked to each other within the program 912 and/or healthcare enterprise simulation model 914.

Referring to FIG. 10, a table is shown that represents the output of the simulation model as a predicted resources database 1000 that may be stored at the healthcare enterprise resource prediction platform 900 according to some embodiments. The table may include, for example, entries identifying areas within a hospital. The table may also define fields 1002, 1004, 1006, 1008, 1010, 1012 for each of the entries. The fields 1002, 1004, 1006, 1008, 1010, 1012 may, according to some embodiments, specify: a unit identifier 1002, a unit name 1004, and time-base resource predictions 1006, 1008, 1010, 1012. The predicted resources database 1000 may be created and updated, for example, based on information received from a healthcare enterprise simulation model.

The unit identifier 1002 may be, for example, a unique alphanumeric code identifying an area within a hospital (e.g., an emergency room, surgery area, etc.) as illustrated by the unit name 1004. The time-based resource predictions 1006, 1008, 1010, 1012 may represent an amount of a resource that is predicted to be available at a particular time. For example, it is predicted that the emergence room (“U_{—}101”) will have 12 beds available at 6:00 PM and 8 beds available at midnight. In other embodiments, these predictions may be accompanied by confidence intervals or other estimates of variance. This information may then be used to make staffing decisions, patient routing decisions, etc.

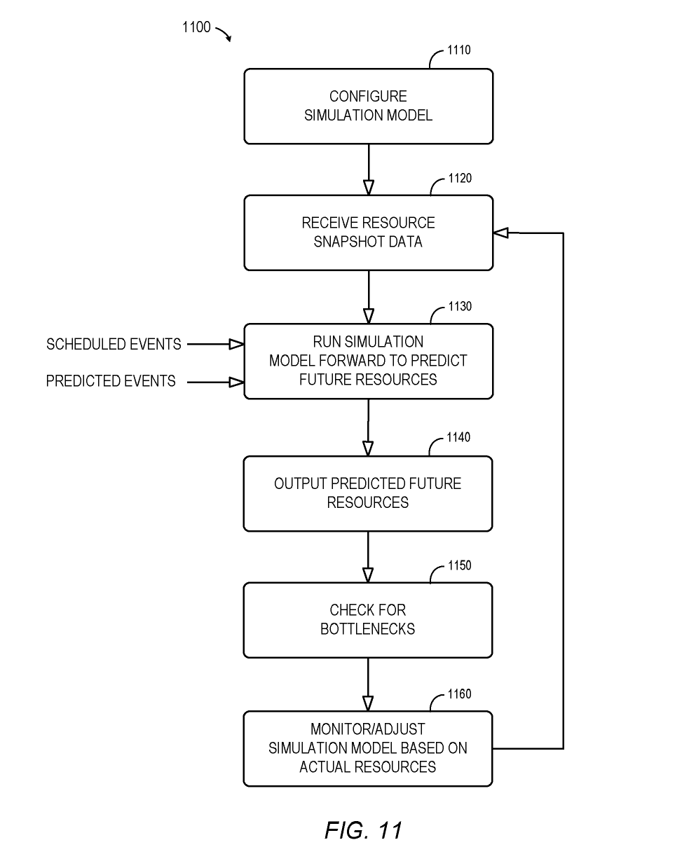

Thus, embodiments described herein may provide automated resource and patient flow management. Moreover, the process may be based on a large scale discrete-event simulation covering the entire hospital ecosystem. For example, FIG. 11 illustrates a process 1100 that might be performed in accordance with some embodiments. At 1110, a simulation model may be configured. The configuration may be associated with a particular hospital's departments, units, process flow, resources, etc.

At 1120, resource snapshot data may be received. According to some embodiments, the simulation is “hot-started” to reflect current hospital conditions including capacities and workflow in emergency, surgery, admitting clinics and inpatient units, and populated with the current, scheduled and “potential” patients expected across the next 24 hours. According to some embodiments, algorithms provide for differing care pathways and practice patterns of individual institutions and care providers.

Upon forecast initiation, data may be extracted from multiple hospital databases and information systems. According to some embodiments, current patients, beds, and in-progress surgeries are provided to the system as a “snapshot” in time. This may include data on each patient's location, entry time and status; the status of each inpatient bed (occupied, available, dirty/clean, out of service); and/or the current status of each surgery (patient in holding, pre-op, OR, recovery, etc.). The model may also utilize planned events such as upcoming surgeries or orders for admission and discharge. Moreover, a large amount of historical patterns may be extracted from previous data to describe the classification scheme for current patients along with potential outcomes (in terms of durations, next-state locations and probabilities) and unscheduled arrival rates and associated pathways through the system.

At 1130, the simulation model may be run forward to predict future resources (which may also be based on scheduled and predicted events). Note that a transfer function operates between inputs and the output predicted future resources. This step may include categorizing each current patient into one of 50 operational modes based on the data available for them (e.g., inpatient with discharge order, surgical patient currently in pre-op, with admission order, or emergency patient, recently arrived, no other data). For each replication of the simulation, a single duration and outcome may be selected for each patient. Each inpatient unit may be assigned its current in-service bed capacity and patients may be initialized into their current locations and states. External arrivals may be added to the simulation based on scheduled cases, pending direct-to-unit admission requests and probabilistic arrival tables. Note that each of these arrival types may have an associated range of variability and outcome, such as the likelihood that a scheduled case will proceed as planned. Finally, all of these elements may be simulated while accounting for priorities and conflicts between patients (competing for inpatient beds or other capacity), and replicated 100 times with potential for different durations, outcomes and arrivals each time.

At 1140, the predicted future resources may be output. According to some embodiments, after a simulation concludes, outputs from all replications may be automatically aggregated and processed to calculate statistics and generate reports that list a forecast output.

At 1150, the predicted future resources may be checked for potential bottlenecks. For example, once a prediction UI is provided, the system may run multiple scenarios configured by the user to reflect the impact of the real life operational decisioning one would take under the constrained capacity conditions. Some of these mitigations may include adding more staff, opening a surge unit, expediting discharges or transfers, canceling admissions, surgical procedures, and maybe even diverting new ED patients to other hospitals. As an example, the future state of cardiology resource availability could be improved if certain actions as configured would take place to avoid expected future bottlenecks. When the Cardiology service line is expected to have bed shortages two hours after the current forecast, it might be determined that the severity of the shortage can reduced by increasing the staffed beds in cardiology units.

The operational decision support cycle supported by the automated analytical workflow may end once the prediction and mitigation reporting is provided to decision-makers (and this cycle may repeat periodically). At 1160, the simulation model may be monitored and/or adjusted as appropriate based on the actual resources that where available at the predicted time. For example, the system and method for forecasting key resource bottlenecks may also be able to monitor the “accuracy” of the predictions and proposed mitigation actions. According to some embodiments, capabilities for background monitoring and learning may also be provided. More specifically, the system may include components for monitoring: the validity of the key historical patterns (e.g., ED arrival rates, volume, patterns, and discharge patterns) and assumptions used in the model; prediction accuracy (e.g., did the system predict occupancy/bed availability correctly at the right time in the right quantity at the right place) including trends; and mitigation accuracy (e.g., did the proposal for mitigation work as expected). The analytical workflow may automatically generate these reports and provides alerts/flags to appropriate users for further analysis for a possible change in the model structure and data assumptions. The process may then continue at 1120 (without reconfiguring the simulation model).

In this way, multiple simulation runs may be analyzed and digested into patient flow and census estimates at the level of individual units, service lines (unit groupings such as heart or medical) and/or the “whole hospital” (all adult-acute patients). Various dashboard views may be created for specific audiences such as unit managers, service line directors, support services, and/or a bed-placement team. Some views may be available through a secure password-protected website using cloud services while others are provided through email (as a message or as an attachment).

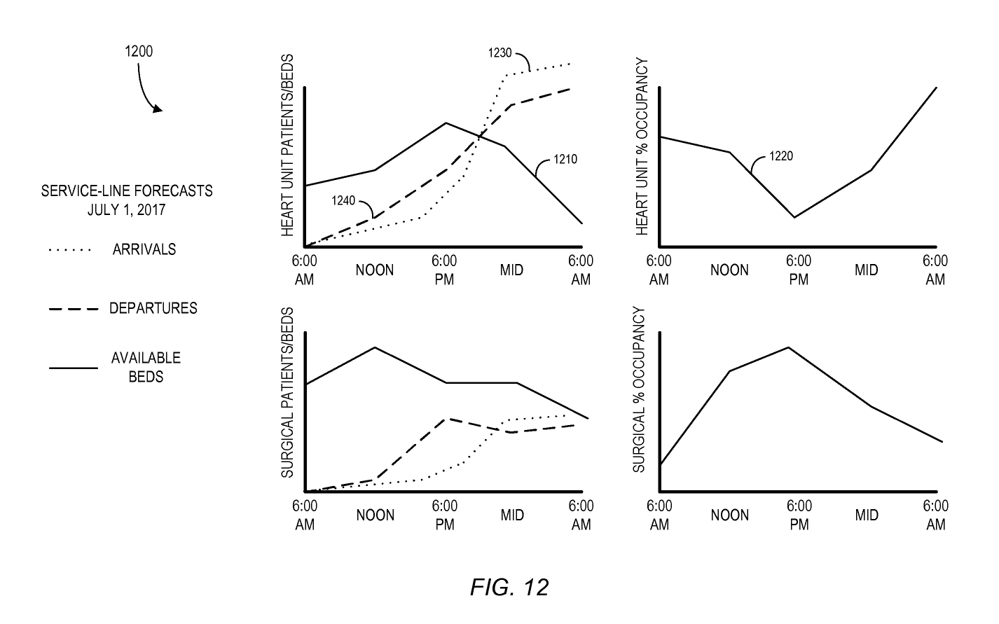

FIG. 12 illustrates a service-line resource prediction display 1200 that might be provided according to some embodiments. The display 1200 includes a graph displaying the number of available beds over time 1210 along with patient arrivals 1230 and patient departures 1240 (over a 24 hour period). Another graph displays percent of occupancy over time 1220. As illustrated in FIG. 12, different graphs can be provided for different units (e.g., heart and surgical units may be displayed separately). Such a display may provide a “macro-level” forecast view covering multiple service lines and a unified context for all departments (to both assess the near-term outlook and evaluate current plans).

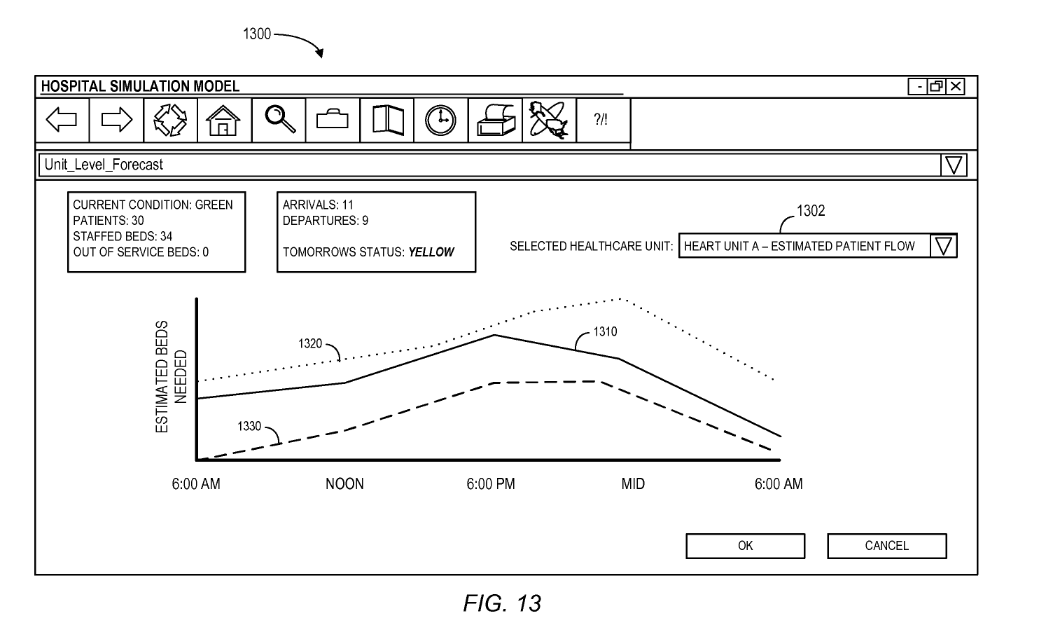

This high-level display 1200 may mask some of the interdependencies within the system, and therefore more granular detail may be available for different audiences. FIG. 13 illustrates a unit level forecast display 1300 that might be provided according to some embodiments, including a number of beds needed 1310 over time as well as a confidence interval comprising a likely high indication 1320 and a likely low indication 1330. A user selection 1302 may be used to let the user view data for another unit. Note that even this display 1300 may exclude some data available from the simulation, including the volatility and timing of arrivals, sources of variability, and/or the probability of certain extreme events (such as a particular volume or spacing of arrivals which overwhelms the unit's short term intake capacity at certain points in the day).

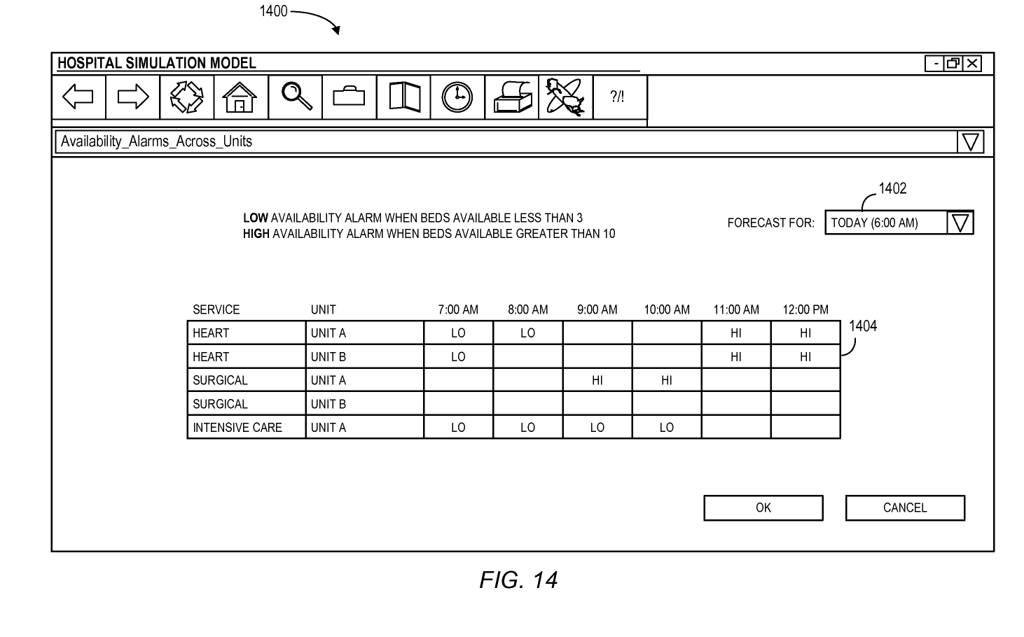

According to some embodiments, customizable alerts can be generated based on specific forecast conditions. FIG. 14 illustrates a low bed availability display 1400 that might be provided in accordance with some embodiments. A user selection 1402 may be used to let the user view data for various time periods. An alarm matrix 1404 may display when low (“LO”) or high (“HI”) patient bed availability alarms are triggered based on predetermined rules. For example, the LO alarm might be display for those time periods where the number of available beds is less than three.

Although some resource prediction displays are provided herein as examples, note that any number of other displays might also be provided. For example, a “heat map” could display forecasted arrival/exit activity by floor, which might help cleaning and transportation staff identify priorities and potential hot-spots across the day. The generated alerts based on forecasted conditions may also be customized, such as a special alert automatically transmitted to a predetermined set of health care providers upon a likelihood of extremely high occupancy. The alerting system may be customized to evaluate other user-defined conditions, such whether the estimated number of arrivals for a particular location exceeds some threshold. These alerts may, for example, be provided through email.

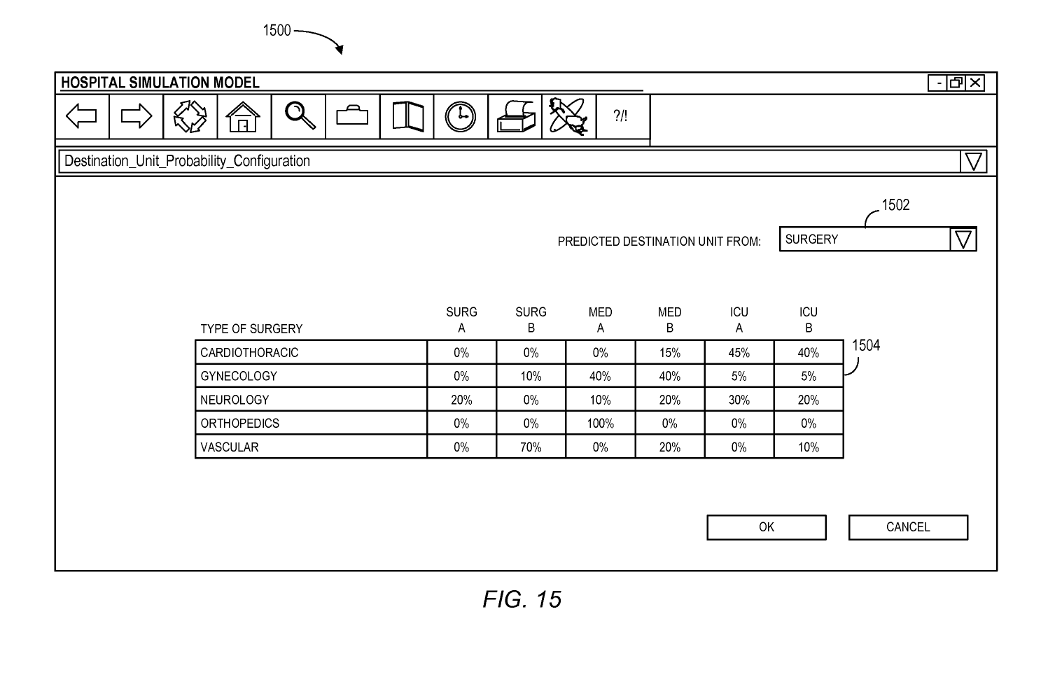

In addition to displays and alerts based on predicted resource information, note that GUIs may facilitate the entry of configuration data for a simulation model. For example, FIG. 15 illustrates a destination unit probability configuration display 1500 that might be provided in accordance with some embodiments. The display 1500 has a user selection 1502 to let a user determine a unit-level view of a destination matrix 1504. The matrix 1504 may be used to define destination unit probabilities. That is, given that a patient is currently in a surgery unit the matrix 1504 defines, based on the type of surgery the patient is undergoing, the likelihood that he or she will next visit each potential next unit. As illustrated by the matrix of FIG. 15, a patient currently undergoing a vascular surgery has a 70% chance of next being in surgery unit B, a 20% chance of next being in medical unit B, and a 10% chance of next being in ICU B.

According to some embodiments, an automated daily calibration may be performed for validation and verification based on a separate snapshot containing the past 24 hours of actual data and compared against the previous day's forecast. This process generates daily reports and long-term monitoring of historical patterns. The daily forecast accuracy might be measured at several levels of granularity, such as all beds in total, service lines, and/or 28 individual units and/or any other grouping as defined during the hospital configuration step.

For long-term monitoring, control charts may be used to monitor the deviation of various patterns to the corresponding real-life data day-by-day and aggregated over time. A control chart may be plotted using daily normalized values to determine whether observed values are within 3 sigma deviation of the estimated value. For certain patterns a quantile-quantile (q-q) plot may be generated to compare the observed cumulative distribution versus the assumed distribution (e.g., to evaluate patient length-of-stay distributions for two separate days of week). Positive and negative cusum values may be calculated over time to identify any statistical shifts between actual values and those expected from the patterns, and can provide notification that a pattern update may be required.

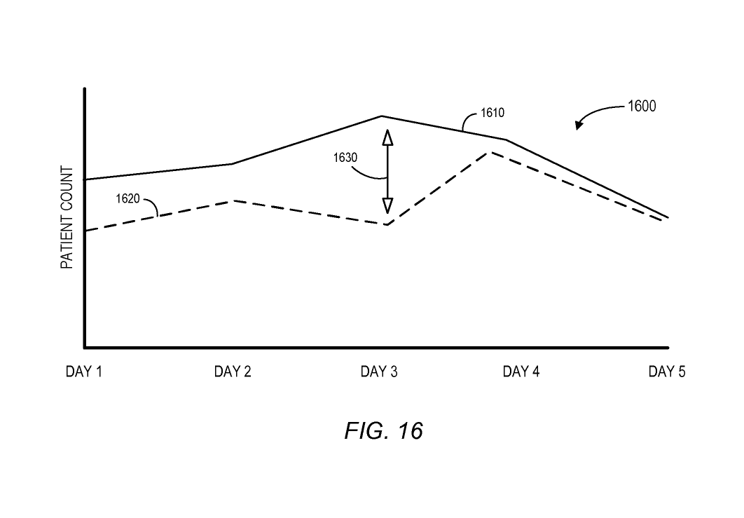

FIG. 16 is an example of a forecasted occupancy daily calibration display 1600 according to some embodiments. In particular, a predicted patient count 1610 may be compared to the actual patient count 1620. When the difference 1630 between the predicted patient count 1610 and the actual patient count 1620 exceeds a predetermined threshold, an adjustment to the model may be appropriate. For example, it might be determined that a predicted number of new visitors to an emergency room during Friday evenings should be lower than currently assumed by the model.

For offline pattern monitoring, an application may store daily calibration statistics and produce a calibration metric database, which enables charting or statistical analysis to identify problem areas and identify aspects of the system performance which can be improved. This may be helpful to visualize large amounts of data and make comparisons between units, service lines, and other groupings. It may also be used to locate interdependencies and imbalances between metrics. For example, one unit within a service line may be receiving too many patient arrivals while another within the same group receives too few. This may require a configuration update to balance out the probabilities of transfer within the set of units.

Scheduled pattern updates may occur periodically, such as every three months, and revisions may be performed based on rolling historical data, ensuring that long term variation is captured in the forecast. In addition to scheduled maintenance, there may be unscheduled modifications due to changes in hospital structure or operations (e.g., changes in workflow, units, or service lines). For example, when a new unit is added to the hospital it may be manually inserted into the simulation model and appropriate patterns may be selected based on assumed “comparable” units—until a sufficient time period has elapsed to permit historical pattern extraction. Code updates to the system might not be required unless there is a new feature to be added or bugs are discovered.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems).

Applicants have discovered that embodiments described herein may be particularly useful in connection with resource predictions for a healthcare enterprise. Note, however, that other types of predictions may also benefit from the invention.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A method, comprising:
receiving snapshot data indicative of a current state of resources that deliver healthcare to a plurality of patients associated with a healthcare enterprise;
automatically using the received snapshot data to initialize a healthcare enterprise simulation model executed by a computer processor; and
executing, by the computer processor, the healthcare enterprise simulation model to automatically generate a predicted future state of the resources at a predetermined point in time.

2. The method of claim 1, wherein said receiving, using, and executing are automatically performed in connection with at least one of: (i) a periodic basis, (ii) a response to a request for a report, and (iii) a response to an occurrence of an event.

3. The method of claim 1, wherein said executing generates a plurality of predicted future states of the resources, each associated with a different predetermined point in time.

4. The method of claim 1, wherein the resources are associated with at least one of:
(i) patient beds, (ii) staffing, and (iii) medical equipment.

5. The method of claim 1, further comprising:
automatically detecting, by the healthcare enterprise simulation model, a potential patient flow bottleneck.

6. The method of claim 5, further comprising:
outputting a warning when the potential patient flow bottleneck is detected.

7. The method of claim 5, further comprising:
automatically generating a mitigation recommendation when the potential patient flow bottleneck is detected.

8. The method of claim 1, further comprising:
providing scheduled future events to the healthcare enterprise simulation model, wherein the predicted future state of the resources is further based on the scheduled future events.

9. The method of claim 1, wherein the predicted future state of the resources is further based on predicted future events.

10. The method of claim 9, wherein the predicted future events are based at least in part historical information of the healthcare enterprise.

11. The method of claim 1, further comprising:
prior to said receiving, configuring the healthcare enterprise simulation model.

12. The method of claim 11, wherein said configuring comprises:
defining a plurality of treatment units of the healthcare enterprise simulation model; and
defining patient flow characteristics into, within, between, and out of the plurality of treatment units.

13. The method of claim 12, wherein the healthcare enterprise simulation model is based at least in part on patient flow molecules, each molecule being associated with: (i) a prior state, (ii) an enter time, (iii) a past length of service, (iv) a remaining length of service, (v) a current state, (vi) a patient attribute, (vii) a departure time, and (viii) a next state.

14. The method of claim 13, wherein the healthcare enterprise comprises a hospital and at least one of the treatment units are associated with at least one of: (i) an emergency department, (ii) an outpatient unit, (iii) a holding room, (iv) an operating room, (v) a recovery room, (vi) a cardiac treatment unit, (vii) a physical therapy unit, (viii) a laboratory, (ix) an X-ray and MRI unit, and (x) an intensive care unit.

15. The method of claim 1, further comprising:
automatically comparing the predicted future state of the resources at the predetermined point in time with the actual state of the resources at the predetermined point in time; and
based on a result of said comparison, performing at least one of: (i) transmitting a warning, and (ii) adjusting the healthcare enterprise simulation model.

16. The method of claim 1, wherein the snapshot data indicative of a current state of resources comprises real time location system information.

17. The method of claim 1, further comprising:
generating a report based on the predicted future state of the resources.

18. The method of claim 17, wherein the report is associated with at least one of: (i) a service-line resource prediction display, (ii) a unit level forecast display, and (iii) a low bed availability display.

19. The method of claim 1, wherein said receiving, using, and executing are performed at least one of: (i) local to the healthcare enterprise, (ii) via a remote cloud-based application, and (iii) partially local to the healthcare enterprise and partially via a remote cloud-based application.

20. A system, comprising:
an input port to receive snapshot data indicative of a current state of resources that deliver healthcare to a plurality of patients associated with a healthcare enterprise; and
a healthcare enterprise simulation model platform including a computer processor to:
use the received snapshot data to initialize a healthcare enterprise simulation model,
execute the healthcare enterprise simulation model to generate a predicted future state of the resources at a predetermined point in time,
compare the predicted future state of the resources at the predetermined point in time with the actual state of the resources at the predetermined point in time, and
based on a result of said comparison, adjust the healthcare enterprise simulation model.

21. The system of claim 20, wherein the computer processor is further to:
detect a potential patient flow bottleneck, and
output a recommended resource adjustment to avoid the patient flow bottleneck.

22. A non-transitory, computer-readable medium storing instructions that, when executed by a computer processor, cause the computer processor to perform a method, the method comprising:
receiving snapshot data indicative of a current state of hospital beds that are used to deliver healthcare to a plurality of patients associated with a hospital;
using the received snapshot data to initialize a hospital simulation model; and
executing the hospital simulation model to generate a predicted future state of the hospital beds at a predetermined point in time.

23. The medium of claim 22, wherein the predicted future state of the hospital beds is further based on: (i) scheduled future events, and (ii) predicted future events.
